(19) United States
(12) Patent Application Publication
(10) Pub. No.: US 2026/0340378 A1
(43) Pub. Date: Oct. 29, 2026

(54) TRAINING NEURAL NETWORKS WITH GRADIENT CHECKPOINTING

(71) Applicant: Arm Limited, Cambridge (GB)

(72) Inventors: Ignazio INDOVINA, Manchester (GB); Maxim NOVIKOV, Sale (GB); Daren CROXFORD, Swaffham Prior (GB)

(21) Appl. No.: 19/189,649

(22) Filed: Apr. 25, 2025

(51) Int. Cl. G06N 3/08; G06V 10/771; G06V 10/82

(52) U.S. Cl. CPC G06N 3/08; G06V 10/771; G06V 10/82

(57) ABSTRACT

A data processing system for training a neural network. The data processing system comprises a storage circuitry configured to store checkpoint data for training the neural network and training configuration data indicative of a data partition for training the neural network. The data processing system also comprises a processing circuitry configured to perform a checkpoint operation for a layer of the neural network. The checkpoint operation comprises: obtaining input feature map data for a layer of the neural network, obtaining the training configuration data, selecting a portion of the input feature map data based on the training configuration data, processing the selected input feature map data in the layer of the neural network to obtain output feature map data, selecting a portion of the output feature map data based on the training configuration data, and storing, in the storage circuitry, checkpoint data derived from the selected output feature map data.

### BACKGROUND OF THE INVENTION

### Field of the Invention

The present invention relates to methods performed by data processing system, and a non-transitory computer-readable storage medium to train a neural network. The disclosure has particular, but not exclusive, relevance to image processing for computer vision.

### Description of the Related Technology

Image signal processors (ISPs) are used to process image data and generate an image output or a classification output. For example, image data could be processed via mathematical operations to produce transformations of the image data that can be mapped to a given output. In some examples, the ISP may be implemented as a neural network that performs operations on the image data to learn and interpret patterns associated with the image data. For example, the ISP may be used to denoise or enhance an image.

In some examples, the ISP may have to process large data sets in order to train a model associated with the neural network. Based on the quantity of data, it may be challenging to train the model, because of constraints associated with training times and memory requirements for forward pass operations (e.g., calculating the output of each of the layers of the neural network) and backward pass operations (e.g., updating weights associated with the layers of the neural network to learn patterns of the image data).

In order to improve performance, and in some cases flexibility in the training process, it is desirable for an ISP to implement a method for reducing the amount of data to be stored in the memory during the training process without significantly impacting the training time of the neural network.

### SUMMARY

According to a first aspect of the present disclosure, there is provided a data processing system for training a neural network, the data processing system comprising: storage circuitry configured to store: training configuration data indicative of a data partition for training the neural network; and checkpoint data for training the neural network; and processing circuitry operably coupled to the storage circuitry, the processing circuitry configured to: perform a checkpoint operation for at least one layer of the neural network, the checkpoint operation comprising: obtaining input feature map data for a layer of the neural network; obtaining the training configuration data; selecting at least a portion of the input feature map data based on the training configuration data; processing the selected input feature map data in the layer of the neural network to obtain output feature map data; selecting at least a portion of the output feature map data based on the training configuration data; and storing, in the storage circuitry, checkpoint data derived from the selected output feature map data; and train at least a portion of the neural network based at least on the stored checkpoint data and a loss function.

According to a second aspect of the present disclosure, there is provided a method of training a neural network comprising a plurality of layers, the method implemented on a data processing system and the method comprising: in a storage circuitry: storing training configuration data indicative of a data partition for training the neural network; and storing checkpoint data for training the neural network; and in a processing circuitry: performing a checkpoint operation for at least one layer of the neural network, the checkpoint operation comprising: obtaining input feature map data for a layer of the neural network; obtaining the training configuration data; selecting at least a portion of the input feature map data based on the training configuration data; processing the selected input feature map data in the layer of the neural network to obtain output feature map data; selecting at least a portion of the output feature map data based on the training configuration data; and storing, in the storage circuitry, checkpoint data derived from the selected output feature map data; and training at least a portion of the neural network based at least on the stored checkpoint data and a loss function.

According to a third aspect of the present disclosure, there is provided a non-transitory computer-readable medium containing program instructions that, when executed by a computer, cause the computer to perform a method of training a neural network comprising a plurality of layer, the method comprising: in a storage circuitry: storing training configuration data indicative of a data partition for training the neural network; and storing checkpoint data for training the neural network; and in a processing circuitry: performing a checkpoint operation for at least one layer of the neural network, the checkpoint operation comprising: obtaining input feature map data for a layer of the neural network; obtaining the training configuration data; selecting at least a portion of the input feature map data based on the training configuration data; processing the selected input feature map data in the layer of the neural network to obtain output feature map data; selecting at least a portion of the output feature map data based on the training configuration data; and storing, in the storage circuitry, checkpoint data derived from the selected output feature map data; and training at least a portion of the neural network based at least on the stored checkpoint data and a loss function.

### BRIEF DESCRIPTION OF THE DRAWINGS

FIG. 1 is a schematic diagram showing a data processing system according to examples;

FIG. 2 is a schematic diagram showing a neural network according to examples;

FIG. 3 is a flow diagram showing a method of training the neural network according to examples;

FIG. 4 is a schematic diagram showing the selection of regions of an input feature map for obtaining checkpoint data according to examples;

FIG. 5 is a schematic diagram showing the selection of input feature maps corresponding to input feature map data according to examples;

FIG. 6 is a schematic diagram showing the selection of regions of output feature map data according to examples;

FIG. 7 is a schematic diagram showing a selection of output feature maps corresponding to output feature map data according to examples;

FIG. 8 is a schematic diagram showing the retrieval of checkpoint data during a forward pass when training a neural network according to examples;

FIG. 9 is a flow diagram showing a method of training a neural network using checkpoint data according to examples; and

FIG. 10 is a schematic diagram showing a non-transitory computer-readable storage medium according to examples.

### DETAILED DESCRIPTION OF CERTAIN INVENTIVE EMBODIMENTS

Certain techniques for training neural networks involve forward pass and backward pass. According to these techniques, a forward pass may be performed by processing training data through the layers of a neural network to obtain an output, or “prediction”. In supervised learning, a loss function may then be used to determine a difference, or “loss” between the output of the neural network and a known or target output. Backpropagation is then used to calculate the gradient of the loss function with respect to the neural network's parameters, such as weights and/or biases. This gradient indicates how much these parameters need to be adjusted to reduce the loss. Optimization algorithms like Stochastic Gradient Descent (SGD) or Adam use the gradients to update the parameters of the neural network.

Batch training in neural networks is a technique in which a training data set is divided into smaller subsets called batches. For example, 256 images may be divided into 32 groups (batches) of 8 images. Instead of updating the neural network's parameters (e.g. weights and biases) after processing each individual data element (e.g., each image), the neural network processes an entire batch of data points (e.g., a batch of 8 images) before its parameters are updated. For example, where the training data set comprises a plurality of images, each batch may comprise a subset of the images to be processed by the neural network.

During the forward pass of training a neural network, the activations (outputs of each layer) may be stored. These activations are used for the backward pass (backpropagation), where the gradients are calculated to update the neural network's parameters. For very deep networks with many layers and/or large batch sizes, storing all these intermediate activations can consume a significant amount of memory, often leading to “out-of-memory” (OOM) errors and limiting the size of the neural network or batch size one can use.

Gradient checkpointing, also known as activation checkpointing, is a technique used when training deep neural networks to trade off memory and execution time in gradient-based tuning. It aims to reduce the memory usage during training, especially for very deep models, by strategically recomputing intermediate activations in the neural network during the backward pass instead of storing all of them during the forward pass.

Gradient checkpointing tackles this memory bottleneck by selectively saving, or “checkpointing”. Instead of storing the activations of every layer during the forward pass, only the activations of a selected subset of layers (called “checkpoints”) are saved. During the backward pass, when the gradients for a particular layer need to be computed, the relevant input activations for that layer are either fetched from memory if they were checkpointed, or, if not written to memory, recomputed on the fly using the activations from the nearest preceding checkpoint. Once the relevant activations are recomputed, the gradients for that layer can be calculated as usual.

By not storing all intermediate activations the memory usage during training may be reduced. This reduction in memory usage may come at the cost of increased computation. Since some activations need to be recomputed during the backward pass, the overall training process may take longer. This trade off may be managed by changing the number of layers that are used as checkpoints in the forward pass. In some cases, checkpointing may be performed periodically through the layers of the neural network, for example, every few layers. More sophisticated techniques may select certain checkpoint layers to balance a reduction in memory usage and computational overhead.

Certain examples described herein provide methods and systems that are configured to implement gradient checkpointing with increased granularity compared to other techniques for gradient checkpointing. By providing increased granularity when performing gradient checkpointing, the examples of the present disclosure have been found to reduce the memory utilization even further compared other gradient checkpointing techniques. Additionally, the examples described herein may increase processing throughput in some cases by enabling sub-layer processing and training of a neural network. The checkpointing techniques described herein also enable training to be performed on portions of a neural network, for example on subsets of the network parameters for each layer.

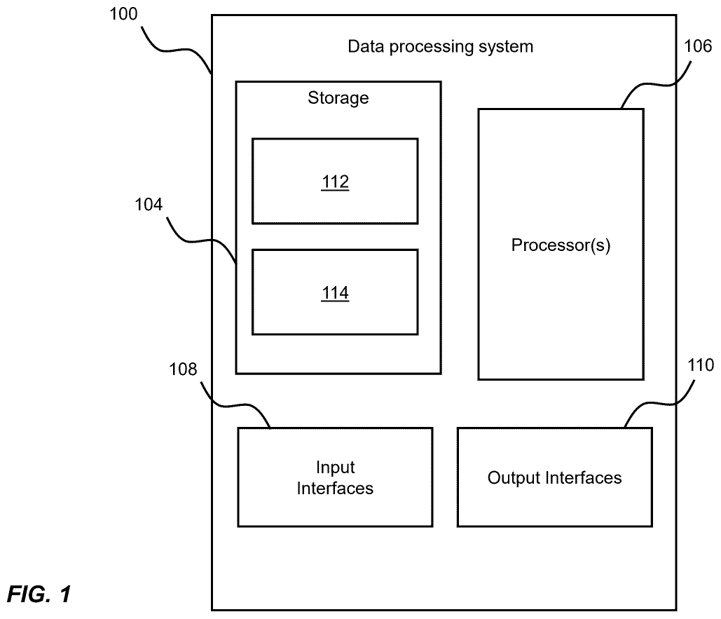

FIG. 1 shows a schematic diagram of a data processing system 100. The data processing system comprises a storage circuitry 104, processing circuitry 106, input interfaces 108, and output interfaces 110. The storage circuitry 104, processing circuitry 106, input interfaces 108, and output interfaces 110 are connected via a bus, which is not shown in FIG. 1 for the sake of simplicity.

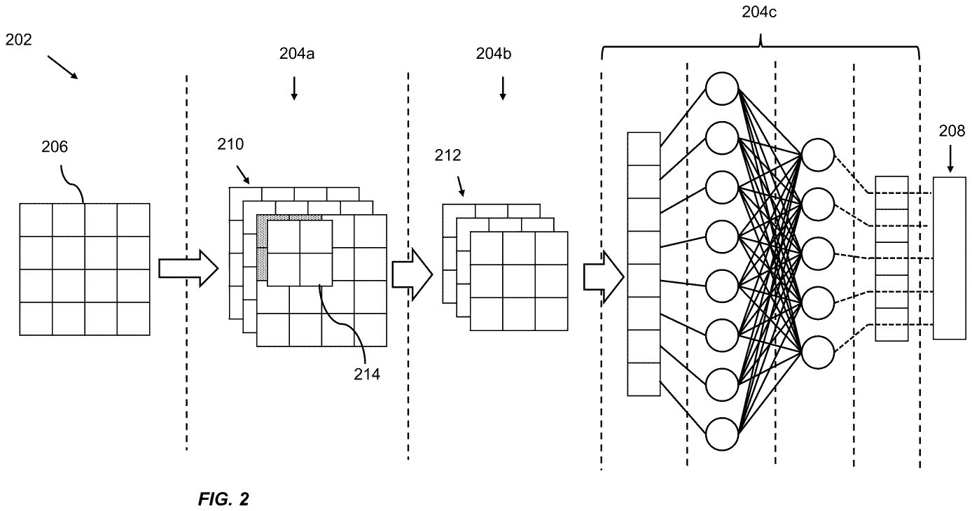

The storage circuitry 104 is implemented using any suitable combination of volatile and non-volatile storage componentry. The storage circuitry 104 may include components such as random-access memory (RAM), such as static RAM or dynamic RAM, or read-only memory (ROM), such as programmable ROM. The storage circuitry 104 may further comprise cache memory or buffers. The storage circuitry may be configured to store checkpoint data 112 and training configuration data 114 which are described further below with respect to FIGS. 2 to 9. The processing circuitry 106 is configured to communicate with the storage circuitry 104 to access or store data.

The processing circuitry 106 may be implemented using any suitable combination of processing componentry, such as a central processing unit (CPU), graphics processing unit (GPU), neural processing unit (NPU), tensor processing unit (TPU), and/or an image signal processor (ISP). The processing circuitry 106 may be configured to perform operations for implementing a neural network, such as multiply-accumulate (MAC) operations. The processing circuitry 106 may comprise one or more processors or processing engines. For example, the processing circuitry 106 may comprise a plurality of compute engines configured to implement neural network operations such as convolution. When executing a neural network, different parts of the neural network may be scheduled for execution on different ones of the plurality of compute engines.

The data processing system 100 may take different forms. In some examples, the data processing system 100 may be a server, distributed hardware for a cloud service, a computer, a mobile device such as a laptop or mobile phone.

The input interface 108 may be implemented using a suitable combination of hardware and/or software components to facilitate communication with the data processing system 100. For example, the input interface 108 may be configured to communicate with one or more input peripherals such as microphones, video cameras, other media capture devices, keyboards, mice and/or tactile inputs such as touch screens or touch pads. The input peripherals may include sensors such as optical, vibration or thermal sensors. For instance, optical sensors may quantify lighting conditions in the form of luminance or color information and provide this information as inputs to the interface 108.

The output interfaces 110 that may include display components such as LCD screens for displaying output data. In some examples, the output interfaces 110 may be configured to connect to external devices that may further process output data generated by the data processing system 100. For instance, external devices may display the processed data or perform actions in response to identifying occurrences or events within the processed data.

FIG. 2 is a schematic diagram of a neural network 202 to which examples of the present disclosure may be applied. The neural network 202 comprises a plurality of layers 204a to 204c, which may be collectively referred to simply as layers 204, that are configured to process input data 206 to produce output data 208. An input layer 204a of the neural network is configured to process input data 206 in the form of input feature map data 210 to generate output feature map data 212. One or more subsequent layers 204b to 204c of the neural network 202 are configured to receive input feature map data from a previous layer and produce output feature map data to serve as input feature map data for a subsequent layer. For example, with reference to FIG. 2, the output feature map data 212 from the first layer 204a is used as the input feature map data for the next layer 204b. The neural network 202 represented schematically in FIG. 2 may be an image classification network. However, it will be appreciated by the skilled person that similar features are to be taken to also apply to other types of neural networks, such as, for example, neural networks that are suitable for image signal processing (ISP).

A feature map, such as an output feature map, is the output of a layer 204a of a neural network after processing data with the weights and/or biases of the layer 204a of the neural network 202. For some layers, an activation function may be applied to an output feature map to obtain an “activation”. In the proceeding description the terms input feature map data 210, output feature map data 212, and generally “feature map” are used. However, it is to be appreciated that the examples described herein may be applied to the activation data, where the output activations of a previous layer are used as the input activations for a subsequent layer of the neural network 202. The neural network may comprise a variety of different layers, for example fully connected, convolutional, deconvolution, recurrent, attention, etc.

One or more of the layers 204 of the neural network 202, may be convolutional layers. In each of the convolutional layers, input feature map data is processed using a kernel 214 (also referred to as a “filter”). A kernel 214 is a matrix of weight values that is passed over the input feature map, performing element-wise multiplications and summing the results at each position to produce a single output value. The distance between each position at which element-wise multiplication and summing is performed is referred to as the stride. As the kernel 214 moves across the input feature map, it is used to generate an output feature map where each value reflects the kernel's response to a specific region of the input feature map. Multiple kernels can be used in a layer to extract different features.

A receptive field of at least a portion of a neural network 202 is generally considered to indicate a portion of the input feature map data 210 which a particular neuron or output feature depends on. When processing image data, it can be considered to be the area of the input image that contributes to the value of a specific output neuron. In the first convolutional layer 204a of the neural network 202 the receptive field is typically equal to the size of the kernel 214. In deeper layers in the neural network 202, the receptive field may be calculated recursively based on the kernel size, a stride, padding, and the receptive field of the previous layer.

The neural network 202 may have multiple receptive fields. For example, when the neural network 202 comprises two convolutional layers followed by a fully connected layer and three deconvolutional layers, there may be two receptive fields of the neural network 202: the first receptive field would be associated to the two convolutional layers, and the second receptive field would be associated to the three deconvolutional layers. The region of the receptive field may change between layers. While in the examples discussed above the receptive field of a neural network has been discussed with respect to convolutional neural networks, it is to be appreciated that other types of neural networks may also be associated with a receptive field which may be dependent on the architecture of the neural network. It will be appreciated by the skilled person that in some cases at least a portion of a neural network (e.g., one or more layers) may be associated with a receptive field.

When training the neural network 202, inference may be performed with test data to determine an error. Typically, output feature maps of each of the layers may be stored. Based on the error and stored output feature map data for each of the layers it is possible to update the weights of each of the layers by back propagating the error. If a memory availability is insufficient for storing the output feature maps of each layer, it is alternatively possible to process data from a previous layer to generate the respective output feature maps for back propagation. For example, when updating the parameters of a given layer 204b of the neural network, the output feature map data 212 of the previous layer 204a may be obtained by performing a forward pass up to the given layer that is being updated. This may lead to large training times due the repetition of computation of the forward pass when training each of the layers 204a to 204c of the neural network 202.

It has been found that, in some cases it is possible to separate the training process into different training sub-steps. In each of these sub-steps, a subset of the weight values associated with one or more of the layers 204b of the neural network 112 may be updated rather than updating weight values associated with the entirety of these layers 204b of the neural network 202. For example, some of the weight values of one or more of the layers 204 may already be close to their desired value, and so it is more computationally efficient to update a subset of the weight values while leaving other weight values unchanged. In other examples, splitting the processing of a given layer 204b of the neural network enables the execution of that layer 204b to be distributed across different cores or processing engines in the processing circuitry 106. Processing a portion of a layer at a time may enable lower memory utilization compared to other checkpointing techniques, which typically involve processing whole layers at a time, because the storage 104 may be used more effectively.

In these cases, storing part of the output feature map data 212 of the layer 204a neural network 202 may be performed, so that at least some of the operations associated with the forward pass can be avoided. While it would be possible in some cases to store the entirety of the output feature map data 212 corresponding to a layer 204a of the neural network 202, this technique presents a challenge due to memory constraints associated with the data processing system 100. The system and methods described herein provide further options when performing check pointing, such that memory constraints of a data processing system 100 may be addressed. For example, it may be possible to achieve a finer granularity in checkpointing, thereby further reducing an amount of memory associated with a checkpoint operation whilst maintaining a reasonable training performance of the neural network 202. In some examples it may be possible to store checkpoint data for a region of a given layer in the storage circuitry 104 and perform back propagation on that region. Other regions of that given layer may then be trained separately by repeating the checkpointing and training operations. Performing training on specific regions of a given layer of the neural network 202, may generally be performed where that given layer is associated with a receptive field. In some examples it may be possible to store the entire layer when performing the checkpoint operation. For example, it may be determined that all the odd layers in the sequence of layers in the neural network 202 are to be checkpointed, and when an even layer is to be processed it may be possible to just process an individual portion of that even layer at a time, thereby reducing an amount of memory associated with storage of even layer data. In some examples, the memory circuitry 104 may store the entirety of some layers of the neural network 202, and smaller sub-portions associated with other layers of the neural network 202. In some cases, the system and methods described herein may be used in conjunction with gradient accumulation techniques, such that partial gradients may be calculated for portions of the neural network 202, and corresponding parameters of the neural network 202 may be updated using an accumulated gradient derived from the partial gradients. A combination of a finer granularity selection of sub-portions associated with layers of the neural network 202, together with gradient accumulation, may enable a higher flexibility when training the neural network 202. For example, it may be possible to reduce a number of updates of the parameters of the neural network 202 when performing batch training.

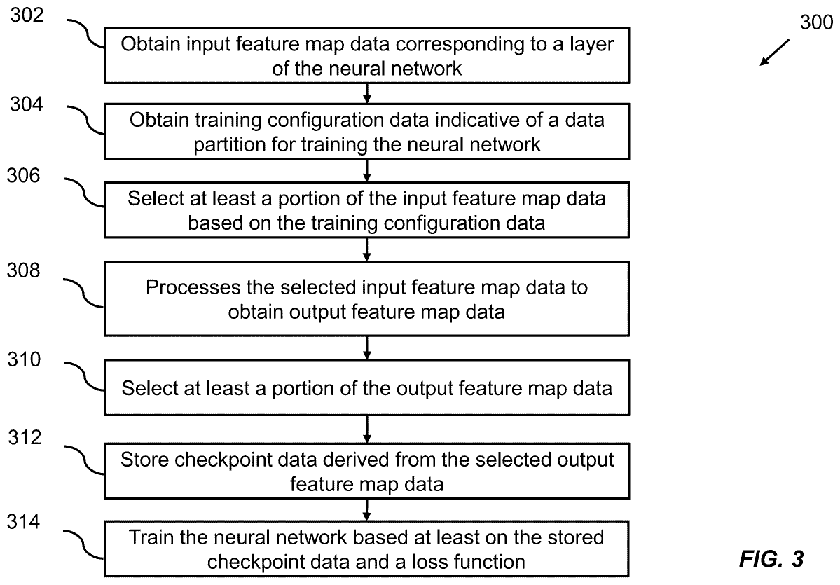

FIG. 3 illustrates a method 300 of training a neural network to be performed by the data processing system 100 which will first be described with respect to the neural network shown in FIG. 2. According to the method 300, the data processing system 100 is configured to apply a data partition when training the neural network 202 to enable checkpointing of output feature map data that can be used to perform partitioned training in the neural network. According to the method 300, the processing circuitry 106 is configured to perform a checkpointing operation for at least one layer in the neural network 202. The checkpointing operation involves obtaining 302 input feature map data 210 corresponding to a layer 204a of the neural network 112.

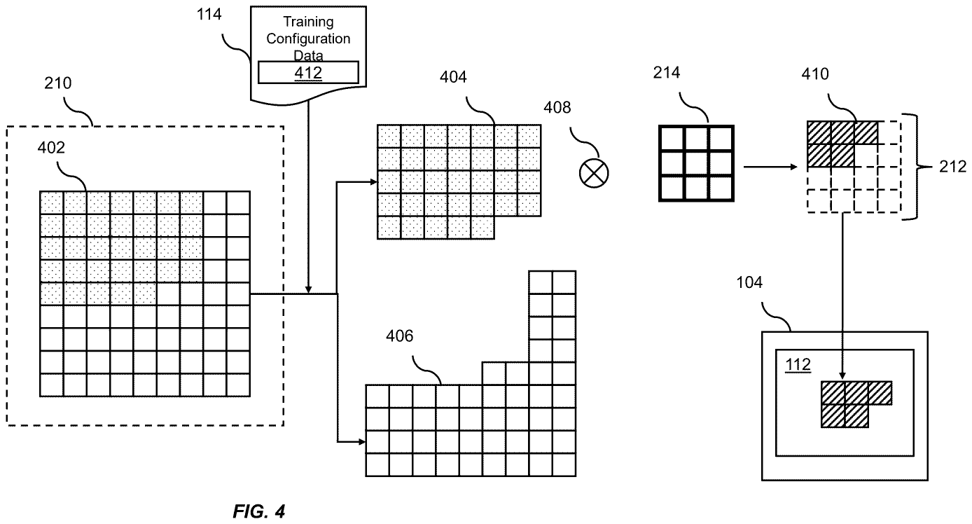

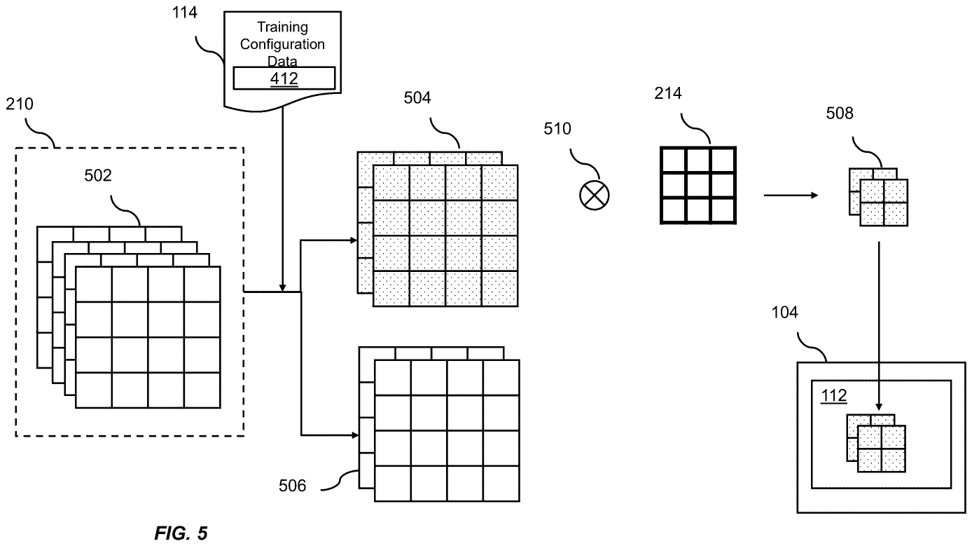

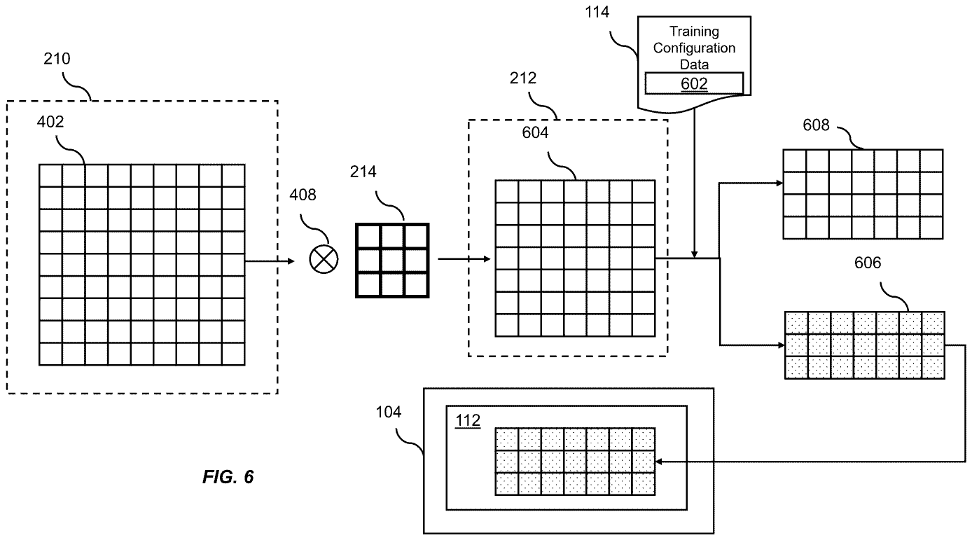

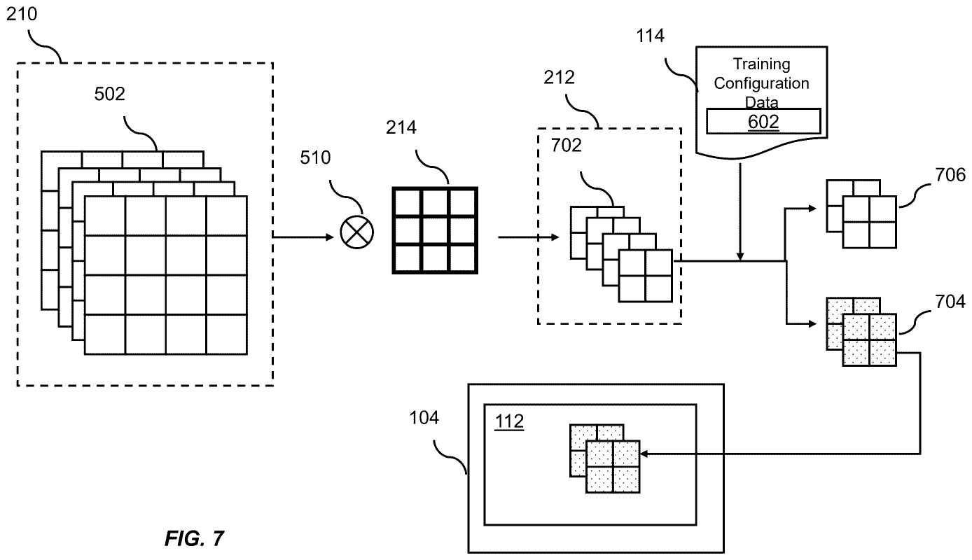

The processing circuitry 106 obtains 304 training configuration data 114 indicative of a data partition for training the neural network 202. The data partition may represent a data partition to be applied to input feature map data and/or output feature map data when training the neural network. Specific examples of how the input feature map data may be partitioned is described with respect to FIGS. 4 and 5 below, while examples of how the output feature map data may be partitioned is described with respect to FIGS. 6 and 7 below.

The processing circuitry 106 subsequently selects 306 at least a portion of the input feature map data 210 based on the training configuration data 114. In some examples, this selection 306 results in the selection of all of the input feature map data 210, while in other examples only a portion of the input feature map data 210 is selected.

The selected portion of the input feature map data 210 is then processed 308 to obtain output feature map data 212. In the example shown in FIG. 2, this processing 308 involves a convolutional operation in which the selected input feature map data 210 is processed using a kernel 214 to obtain the output feature map data 212. However, it is to be appreciated that in other examples the layer 204a may not be a convolutional layer. For example, the layer 204a may involve a recurrent layer, a fully connected layer, a pooling layer, an attention mechanism, and so forth.

At least a portion of the output feature map data 212 is then selected 310 based on the training configuration data 114. This selection 310 may result in the selection of all of the output feature map data 212 or a subset of the output feature map data 212. Checkpoint data 112 is then stored 312 in the storage circuitry 104 by deriving the checkpoint data 112 from the selected output feature map data 212. Generally, where a portion of the input feature map data 210 is selected 306 for processing 308, the checkpoint data 112 will be derived from all of the output feature map data 212. Alternatively, where all of the input feature map data 210 is selected 306 for processing 308, then the checkpoint data 112 will be derived from a selected portion of the output feature map data 212. The neural network 202 is then trained 314 based at least on the stored checkpoint data 112 and a loss function.

By selectively processing input feature map data 210 and/or selectively storing output feature map data 212 as checkpoint data 112, it becomes possible to increase the granularity with which checkpointing techniques can be performed when training a neural network 202. By increasing the granularity of checkpointing operations when performing the forward pass, it becomes possible to efficiently train parts of the neural network 202 separately. Alternatively, or additionally, these techniques may reduce the computational overhead, such as, for example an instantaneous memory requirement of the data processing system 100, by avoiding at least some of the inference operations that are performed during back propagation, while mitigating a storage overhead that may otherwise occur if the checkpoint data 112 includes output feature map data 212 for the entire layer 204a.

In some examples, the method 300 described above may be combined with gradient accumulation techniques during training. This may include, for example, computing partial gradient data and accumulating the partial gradient data to obtain accumulated gradient data. The accumulated gradient data may then be used to update neural network parameters. Using accumulated gradient data in this way may reduce the number of operations to update the parameters of the neural network.

FIG. 4 shows an example in which the method 300 involves selectively processing part of the input feature map data 210. In this example, the training configuration data 114 includes an input data partition parameter 412 that indicates a partition to be applied to the input feature map data 210. The input feature map data 210 comprises an input feature map 402, representing a multi-dimensional data array. The multi-dimensional array may include image data, 3-D image data, medical image data representative of a plurality of slices of biological material or the like, or other types of data. The input data partition parameter 412 is used to apply a partition to the input feature map 402 to obtain a selected portion 404 and an unselected portion 406 of the input feature map 402.

The selected portion 404 of the input feature map 402 is then processed in the layer 204a, for example by applying a convolution 408 using the kernel 214 to obtain output feature map data 410. The unselected portion 406 of the input feature map 402 is skipped and not processed in the layer 204a. The output feature map data 410 that is generated in this example represents a portion of the output feature map data 212 that would have been generated had all of the input feature map data 210 been processed in the layer 204a. All of the output feature map data 410 that is generated is then selected to be stored as checkpoint data 112 in the storage circuitry 104. In the example shown in FIG. 4, only a single selected portion 404 and a single unselected portion 406 of the input feature map 402 are generated. It is to be appreciated that in other examples, a plurality of selected portions of the input feature map 402 may be generated. These selected portions may relate to contiguous or separate regions of the input feature map 402. Similarly, a plurality of unselected portions of the input feature map 402 may be generated. In some examples, the partition may include a horizontal region across the input feature map 402, a vertical region across the input feature map 402, or a rectangular or square region in the input feature map 402. For example, the input feature map 402 may be split into quadrants (e.g., top left, top right, bottom left and bottom right) or smaller regions (e.g., 16×16 pixel regions). While the term “region” has been used to describe the partitioning of an input feature map 402, it is to be understood that a region may include a volume. For example, where the input feature map data 402 comprises a multidimensional array of data values having three or more dimensions, the partitioned regions may include data values from three or more of those dimensions.

In this way, the data processing system 100 may be configured to process only part of a layer 204a of the neural network 202 when performing a forward pass, and checkpoint data 112, corresponding to the part of the layer 204a of the neural network 202, may be stored. This enables more granular checkpoint data 112 to be generated, in which checkpoint data 112 can be stored for a portion of a layer 204a of the neural network 202, than other techniques.

The input data partition parameter 412 used to partition the input feature map data 210 enables the training of the neural network to be tuned by selecting how much of the input feature map data 210 is to be processed in the layer 204a of the neural network 202. In some examples, the input data partition parameter 412 indicates a proportion of the input feature map 210 which is to be selected. For example, where the input feature map 210 comprises a 9×9 array of data values, the input data partition parameter 412 may indicate a number of 3×3 arrays of data values within the input feature map 210 which are to be selected. In other examples, the input data partition parameter 412 may indicate a portion of the layer 204a of the neural network 202 which is to be trained. In some cases, the data processing system 100 may be configured to update weight values corresponding to a portion of the layer 204a. In this case, the input data partition parameter 412 may be used to identify selected portions 404 of the input feature map 402 which correspond to the portion of the layer 204a which is to be updated during training.

It should be noted that the examples discussed in the context described herein relate to arrays of data values of a relatively small size (e.g., 9×9 or 3×3) for the sake of simplicity and to aid clarity. It will be appreciated by the skilled person, that there may be examples in which the arrays of data may be much larger (e.g., 1920×1080 or 1920×1080×64), and the same working principles are to be taken to apply.

In some examples, obtaining the training configuration data 114 may comprise determining a receptive field of the neural network 202 and generating the input data partition parameter 412 based on the receptive field. For example, where the receptive field corresponding to the first layer 204a of the neural network 202 is equal to a 3×3 region in the input feature map 402, the input data partition parameter 412 may specify that a region that is equal to or greater than 3×3 is to be selected. It is to be appreciated that he receptive field of the neural network 202 may be different for each layer. In this case, the training configuration data 114 may comprise a respective input data partition parameter 412 for each layer that is to be checkpoint.

In other examples, the receptive field may correspond to a receptive field over the whole neural network 202. In this case, the region of the input feature map 402 that is indicated by the input data partition parameter 412 may be larger than the receptive field for the given layer 204a.

FIG. 5 shows an example in which the method 300 involves selectively processing part of the input feature map data 210 by partitioning the input feature map data 210 across a batch dimension. As described above, data may be processed in a neural network 202 in batches. In the example of FIG. 5, the input feature map data 210 comprises a batch of input data including a plurality of input feature maps 502. Each of these input feature maps 502 may correspond to an image or sample in a batch. According to this example, selecting 308 at least a portion of the input feature map data 210 comprises applying the partition represented by the input data partition parameter 412 to obtain a set of selected input feature maps 504 and a set of unselected input feature maps 506. In the example shown there are two selected input feature maps 504 and two unselected input feature maps 506, however, it is to be appreciated that the number of selected 504 and unselected 506 input feature maps may be different. In some examples there may be one selected input feature map 504 and/or one unselected input feature map 506.

The selected input feature maps 504 are then processed in the layer 204a of the neural network 202, for example by applying a convolution 510 with the kernel 214, to obtain output feature map data 508 while processing is skipped for the unselected input feature maps 506. The output feature map data 508 may then be used to derive checkpoint data 112 which is stored in the storage circuitry 104 for this layer 204a of the neural network 202. In this way, the data processing system 100 may be configured to process only part of a batch of input feature map data 210 for a given layer 204a of the neural network 202. In this example, the input data partition parameter 412 may be configured to balance characteristics of the data processing system 100 and/or the execution of the neural network 202. For example, the available storage capacity in the storage circuitry 104, the execution time of the neural network 202, and the energy consumption of the neural network 202 may be considered when determining the input data partition parameter 412. For example, input feature maps 502 may be divided into four portions, and parameters of the neural network 202 corresponding to each of the four portions of the input feature maps 502 may be updated separately (e.g., the training process is divided into four training steps, each corresponding to a different portion of the neural network 202).

The examples shown in FIG. 5 and FIG. 6 may be combined. For example, where the input feature map data 210 comprises a plurality of input feature maps 502, the partition may be applied across the batch dimension and to select regions within one or more of the input feature maps 502. This may involve selecting portions of one or more of the input feature maps 502 to be processed in the layer 204a while leaving other portions of the input feature maps and/or other input feature maps unselected.

FIG. 6 shows an example in which the method 300 involves deriving checkpoint data 112 for a given layer 204a from select portions of the output feature map data 212 for that layer 204a. According to the example shown in FIG. 6, the training configuration data 114 comprises an output data partition parameter 602 that indicates a partition to be applied to the output feature map data 212. The input feature map data 210 comprises an input feature map 402 that is processed in the layer 204a of the neural network by applying a convolution 408 using the kernel 214, resulting in an output feature map 604. The partition specified by the output data partition parameter 602 is then applied to the output feature map 604 to obtain a selected portion of the output feature map 606 and an unselected portion of the output feature map 608. The checkpoint data 112 for this layer 204a is then derived from the selected portion of the output feature map 606. In this example, the unselected portions of the output feature map 608 are not stored as checkpoint data 112. The unselected portions 608 may, for example, be discarded or overwritten in the data processing system 100, thereby reducing the storage requirements for the checkpoint data 112 for this layer 204a.

In this example, the partition applied to the output feature map 604 selects one or more regions in the output feature map 604 for checkpointing. To this end, the output data partition parameter 602 may be obtained in a similar manner to the input data partition parameter 412 described above with respect to FIG. 5. Specifically, the output data partition parameter 602 used to partition regions of the output feature map 604 may be based on a receptive field of the neural network 202. The example of FIG. 6 may be combined with the examples shown in FIGS. 4 and 5. This may involve selectively processing portions of the input feature map data 210 and, subsequently, selectively storing portions of the output feature map data 212 as checkpoint data for the layer 204a.

FIG. 7 shows an example in which the method 300 involves deriving checkpoint data for a given layer 204a from output feature maps that are partitioned across a batch dimension. In this example, the input feature map data 210 comprises a batch having a plurality of input feature maps 502, similar to that shown in FIG. 5. The plurality of input feature maps 502 are processed in the layer 204a of the neural network 202 to obtain output feature map data 212 comprising a plurality of output feature maps 702. In the example shown, each of the output feature maps 702 corresponds to a respective one of the input feature maps 502. The partition indicated by the output data partition parameter 602 may then be applied to the output feature maps 502 to obtain a set of selected output feature maps 704 and a set of unselected output feature maps 706. The selected output feature maps 704 may then be used to derive the checkpoint data 112 that is subsequently stored in the storage circuitry 104. The unselected output feature maps 704 are not used to derive the checkpoint data 112 and may be discarded, or overwritten, in the data processing system.

The examples shown in FIGS. 6 and 7, in which checkpoint data 112 is derived selectively from output feature map data 212, enable granular checkpoint data 112 to be stored during a forward pass of the neural network 202. When performing backpropagation on the neural network 202, the checkpoint data 112 may be used to process or update different portions of the neural network 202 at different times.

The checkpoint operation, described above with respect to FIGS. 4 to 6, may be performed for a plurality of layers in the neural network 202. While the examples described above involve applying the checkpointing operation to the first layer 204a of the neural network 202, the checkpointing operation may similarly be applied to one or more further layers 204b to 204c of the neural network 202. In some examples, the method 300 involves processing the training configuration data 114 to select one or more of the plurality of layers 204a and 204c of the neural network 202 for which the checkpoint operation is to be performed. The checkpoint operation may then be performed for those selected layers. By performing the checkpoint operation for a plurality of layers 204a and 204c in this way it becomes possible to train the neural network 202 while further reducing storage overheads compared to other checkpointing techniques. It is also possible to balance the computational overhead that is incurred when inference operations are performed during backward pass.

It is to be appreciated that the checkpoint operation may be applied differently in different layers. For example, in a first layer 204a the checkpoint operation may involve applying the partition to the input feature map data 210 according to the examples shown in FIG. 4 or FIG. 5, while for a second layer 204c, the checkpoint operation may involve applying a partition to the output feature map data when storing checkpoint data 112 for that layer 204c, according to the examples shown in FIG. 6 or FIG. 7.

Where the same type of checkpoint operation is applied to two different layers 204a and 204c, the checkpoint operation may be modified for each of these layers. For example, the size, number, and/or positions of regions in the respective input feature map data which are selected based on the training configuration data 114 may differ between these layers 204a and 204c. The training configuration data 114 may include a respective input data partition 412 parameter and/or output data partition parameter 602 for each layer 204a and 204c to which the checkpoint operation is to be applied.

The training configuration data 114 may be generated based on a number of operating parameters of the data processing system 100. For example, the training configuration data 114 may be generated based on a storage capacity of the storage circuitry 104. The storage circuitry 104 may be associated with a fixed storage capacity based on the size and/or number of components used to implement the storage circuitry 104. Generating the training configuration data 114 may involve determining the storage capacity of the storage circuitry 104, determining a storage utilization based on, for example, one or more scheduled or expected operations in the data processing system 100, and generating the training configuration data 114 based on the storage capacity and the storage utilization.

For example, where the storage capacity is low and/or the storage utilization is high, the training configuration data 114 may indicate that the checkpoint operation is to be applied to few layers in the neural network 202, thereby increasing the compute overhead during training while reducing the amount of checkpoint data 112 to be stored. Where the storage capacity is high and/or the storage utilization is low, the training configuration data 114 may indicate that the checkpoint operation is to be applied to more layers of the neural network, thereby reducing the computational overhead while increasing the amount of checkpoint data 112 that is to be stored.

Similarly, where storage capacity is low and/or storage utilization is high, an input data partition parameter 412 may be indicative of a highly selective partition to be applied to the input feature map data 210 thereby reducing the amount of checkpoint data 112 to be stored. Conversely, where the storage capacity is high and/or the storage utilization is low, the input data partition parameter 412 may be indicative of a less selective partition to be applied to the input feature map data 210 thereby increasing the amount of checkpoint data 112 to be stored.

Where the storage capacity is low and/or storage utilization is high, an output data partition parameter 602 may be indicative of a highly selective partition to be applied to the output feature map data 212 thereby reducing the amount of checkpoint data 112 to be stored. Conversely, where the storage capacity is high and/or the storage utilization is low, the output data partition parameter 602 may be indicative of a less selective partition to be applied to the output feature map data 212 thereby increasing the amount of checkpoint data 112 to be stored.

Other operating parameters of the neural network 202 which may be considered when generating the training configuration data 114 include an expected execution time for the neural network 202. To reduce the expected execution time of the neural network 202 during training, the data processing system 100 may be configured to determine training configuration data 114 such that a larger amount of checkpoint data 112 is stored in order to decrease a number of operations associated with forward passes during the training process of the neural network 202. This may decrease the training time of the neural network 202. In this way the data processing system 100 may be configured to trade off training time for memory usage and vice versa.

Energy consumption corresponding to processing one or more layers of the neural network 202, a communication bandwidth between the processing circuitry 106 and the storage circuitry 104, and a size of a cache or buffer in the processing circuitry 106, are further examples of operating parameters that may be considered when generating the training configuration data 114.

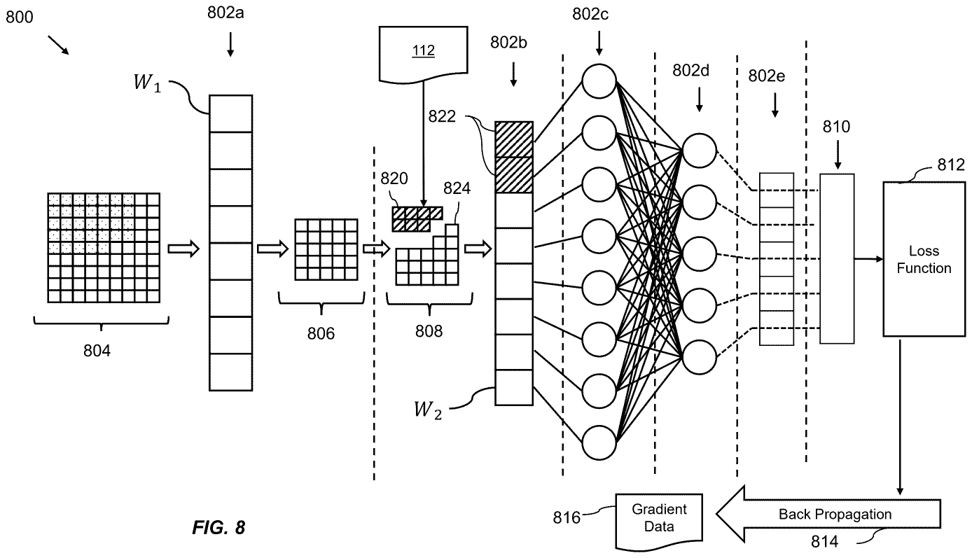

FIG. 8 shows an example of training a neural network 800 using checkpoint data 112. The example of FIG. 8 shows a plurality of layers of a neural network 802a to 802e. An input to the neural network 802a includes input feature map data 804. Each layer 802a to 802e of the neural network 800 is associated with a corresponding set of network parameters W. For example, the first layer 802a includes network parameters W₁ and the second layer 802b includes network parameters W₂. These network parameters W₁ or W₂ may include, for example, weights and/or biases of the first layer 802a.

The input feature map data 804 is processed in the first layer 802a to obtain output feature map data 806. The output feature map data 806 is used as an input feature map 808 for the second layer 802b of the neural network 800. Processing in the forward pass continues in this way until an output 810 is obtained. A loss function 812 is applied to determine a loss value of the output 810 of the neural network 800 compared to an expected or target output. This loss value is then used in the backpropagation process 814. During backpropagation 814, the gradient of the loss function 812 with respect to each of the network's weights is calculated using the chain rule of calculus, propagating the error backwards through the network 800. At each layer 802a to 802e, during back propagation, gradient data 816 is derived which represents these gradients. These gradients indicate how much each weight value of a given layer 802a to 802e contributed to the overall error. These gradients are used by an optimization algorithm (like gradient descent) to update the weights W, aiming to minimize the loss in subsequent forward passes and thereby improving the network's performance.

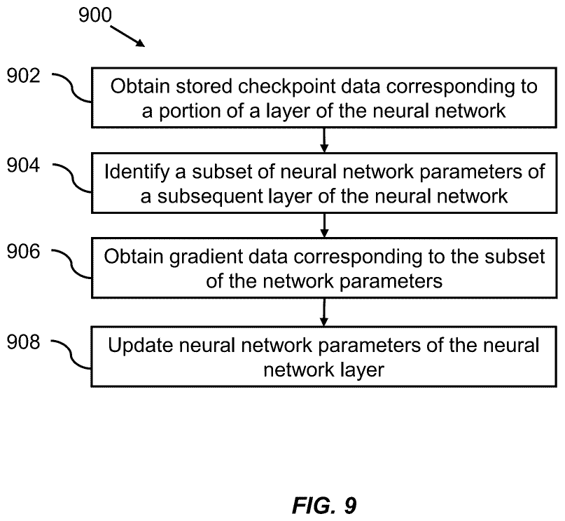

FIG. 9 shows an example of operations that may be performed for a given layer 802b in the neural network 800 as part of a method 900 to be used when performing training, which will now be described also with reference to FIG. 8. In this example, a checkpoint operation has been applied to the first layer 802a such that at least some of the output feature map data 806 of the first layer 802a is stored as checkpoint data 112. When performing training on the second layer 802b of the neural network 800, the stored checkpoint data 820 corresponding to the previous layer 802a is obtained 902. This is shown as a portion 820 of the input feature map 810 for the second layer 802b. It is to be appreciated that the checkpoint data 112 may include further data, for example, checkpoint data corresponding to one or more further layers 802c to 802e of the neural network 800.

A subset of the network parameters W₂, that correspond to the stored checkpoint data 820 is identified 904. In this example, the subset of the network parameters W₂ that are identified may correspond to a region or portion 822 of the second layer 802b which are to be used to process the stored checkpoint data 820. Gradient data 816 corresponding to the subset of the network parameters W₂ may then be obtained 906, for example, using gradient descent backpropagated through one or more subsequent layers 802c to 802e of the neural network 800.

The subset of network parameters W₂ may then be updated 908 based at least on the gradient data 816. In certain examples, obtaining the gradient data 816 involves processing the stored checkpoint data 820 with the subset of the parameters W₂ in the second layer 802b. The gradient data 816 may then be determined based on the gradient of the loss of function 812 with respect to the output of the second layer 802b when processing the stored checkpoint data 820.

In this example, in which training of the second layer 802b involves updating a subset of the network parameters W₂ of the second layer 802b, the loss function 812 may be a partial loss function. In some cases, it is possible to obtain a partial output 810 of the neural network 800, for example, when applying the checkpoint operation to selectively process portions of the input feature map data 804 through the network 800. In this case, the loss function 812 may be a partial loss function configured to determine a loss over the partial output 810 which may then be backpropagation through the network 800.

In other examples, the use of the stored checkpoint data 820 may be combined with recomputing inference of the previous layer 802a. For example, the stored checkpoint data 820 may be obtained from the checkpoint data 112 in storage 104 while the remaining portion of the input feature map 824 may be obtained by recomputing at least part of the previous layer 802a to generate that portion 824. In this example, all of the network parameters W₂ of the second layer 802b may be updated using gradient data 816 by processing both the stored checkpoint data 820 and the recomputed portions of the input feature map 824 in the second layer 802b to determine the gradient data 816.

In the example shown, the stored checkpoint data 820 corresponds to an immediately previous layer 802a to the current layer 802b being trained. It is to be appreciated in other examples, such as where the layer being trained is the first layer 802a, the checkpoint data 820 may be used directly to calculate the gradient data 816 and update at least some of the network parameters W₁ of that layer 802a. In a general case, when training a said layer 802b to 802e of the neural network 800, checkpoint data 112 for the nearest previous layer 802a to 802d may be obtained from the storage 104. The obtained checkpoint data 112 may then be reprocessed through the network 800 up to the current layer that is being trained 802b to 802d so that the gradient data 816 may then be calculated for that layer 802b to 802d.

As described above, checkpoint data 112 may comprise data derived from input feature map data 210 and/or output feature map data 212 partitioned across a batch dimension. In this case, the gradient data 816 may represent partial gradient data that can be used to updated parameters of the neural network. For example, partial gradients may be sent to a gradient accumulation buffer, and an accumulated gradient may be computed as a sum of the partial gradients. In this examples, the corresponding neural network parameters W may be updated using the accumulated gradient, rather than performing multiple parameter updates associated with each of the partial gradient data. This may be referred to as gradient accumulation.

The processing circuitry 106 of the data processing system 100 may include a plurality of separate compute engines, or cores. When processing a layer of the neural network 202, the processing circuitry 106 may distribute computations corresponding to the layer 204a of the neural network between the separate cores. This may accelerate an execution time associated with the neural network 202, since multiple operations can be executed in parallel by the plurality of cores in the processing circuitry 106. For example, the processing circuitry 106 may perform scheduling of the multiple operations among the plurality of cores depending on a current state of the cores (e.g., a number of processes that are already being executed by one or more cores) and a predicted state of the cores (e.g., a number of processes that are scheduled for execution by one or more cores). The checkpoint operations described above may enable gradient checkpointing to be efficiently applied differentially on different cores of the processing circuitry 106 when training the neural network 202.

In some examples, scheduling of the multiple operations among the plurality of cores corresponds to one or more cores performing checkpoint operations to store output feature map data 212 corresponding to one or more layers 204 of the neural network 202. With reference to the above-described examples of FIGS. 4 to 7, the processing circuitry 106 may allocate processing of the selected portions of input feature map data 210 between one or more cores to generate output feature map data 214. The selected portions of the input feature map data 210 may be allocated by the processing circuitry 106 to one or more cores based on the input data partition parameter 412, following a partition of the input feature map data 210, based on a sub-portion of an input feature map (as explained above with reference to FIG. 4), or a partition in a batch dimension (as explained above with reference to FIG. 5). Each of the one or more cores may then process the input feature map data 210 using a kernel 214 to obtain corresponding output feature map data 212. Similarly, the processing circuitry 106 may allocate processing of the selected portions of output feature map data 212 to obtain checkpoint data 112 between the one or more cores depending on a partition defined by the output data partition parameter 602.

In some cases, the processing circuitry 106 determines a state of the storage circuitry 104 and stores 312 the checkpoint data 112 in one or more parts of the storage circuitry 104. For example, based on a size of data corresponding to the checkpoint data 112, the processing circuitry 106 may determine that a memory availability of a RAM comprised in the storage circuitry 104 is insufficient for storing the checkpoint data 112. Accordingly, the processing circuitry may allocate a first portion of the checkpoint data 112 to the RAM, such that the portion of the checkpoint data 112 to be stored in the RAM does not cause a memory overflow in the RAM, and a second portion to a ROM comprised in the memory circuitry 104.

In some cases, the data processing system 100 is an image signal processor (ISP) and is configured to process input image data. The data processing system may be configured to perform inference on input image data to produce an output prediction. In some examples, the ISP may perform classification tasks (e.g., image recognition, object detection, depth mapping, image segmentation), and the output prediction is a classification output. In some other examples, the ISP performs image transformations (e.g., denoising, boundary detection, style transfer) and the output prediction is an image output. In some cases, the ISP may be a differentiable ISP.

A differentiable ISP may be configured to propagate gradients relating to layers that correspond to each of the batches. Effectively, this may enable a distribution of the gradient computation process, thus leading to more granular checkpointing operations, comprising, for example a combination of checkpointing across a batch dimension (as explained above in relation to FIGS. 5 and 7) and a portion of an input or output feature map (as explained above in relation to FIGS. 4 and 6). In the context of batch training, the differentiable ISP may accumulate partial gradient data from different portions of output feature maps of a layer neural network and perform backpropagation to update corresponding weights.

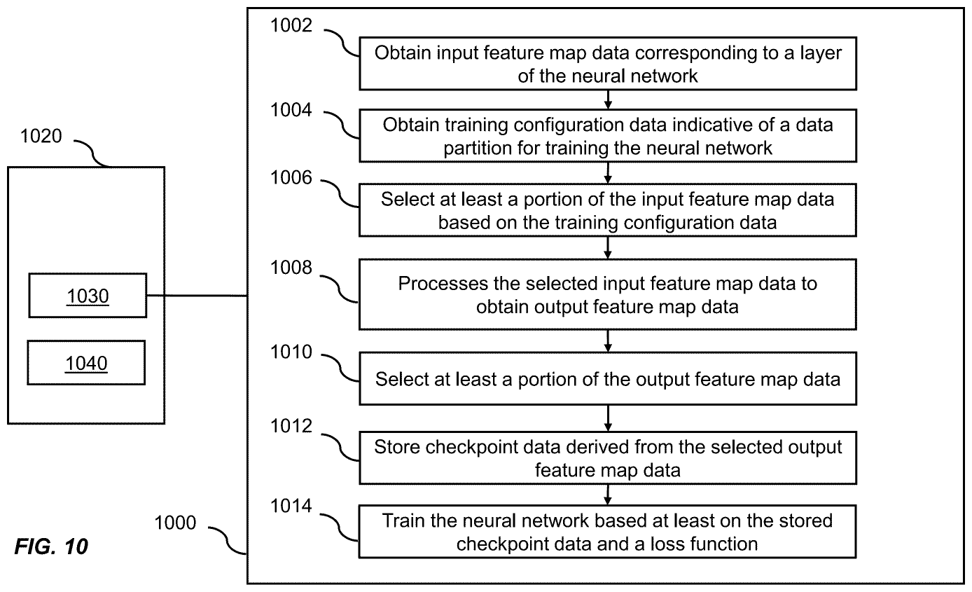

FIG. 10 illustrates a computer readable medium 1000 which contains a set of instructions 1002 to 1014 and can be executed by a processor 1030 within a data processing system 1020 to select checkpoint data of output feature map data of a neural network for training the neural network. When executed by the data processing system 1020, the instructions 1002 to 1014 causes the processor 1030 to obtain 1002 input feature map data corresponding to a layer of the neural network and obtain 1004 training configuration data indicative of a data partition for training the neural network. The processor 1030 then selects 1006 one or more portions of the input feature map data based on the training configuration data and process 1008 the selected input feature map data to obtain output feature map data. In some examples, instructions 1006 and 1008 may correspond to the operations described in relation to FIGS. 4 and 5. The processor 1030 then selects 1010 one or more portions of the output feature map data. In some examples, instruction 1010 may correspond to the operations described in relation to FIGS. 6 and 7. The processor 1030 then stores 1012, in a storage circuitry 1040 comprised in the data processing system 1020, checkpoint data corresponding to the selected portions of output feature map data. The processor 1030 then trains the neural network using a loss function and the stored checkpoint data, or a portion thereof. The neural network may then be trained based on the instruction 1014.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

What is claimed is:

1. A data processing system for training a neural network comprising a plurality of layers, the data processing system comprising:
storage circuitry configured to store:
training configuration data indicative of a data partition for training the neural network; and wherein the training configuration data comprises at least one of:
an input data partition parameter that indicates a partition to be applied to the input feature map data; and
an output data partition parameter that indicates a partition to be applied to the output feature map data; and
checkpoint data for training the neural network; and
processing circuitry operably coupled to the storage circuitry, the processing circuitry configured to:
perform a checkpoint operation for at least one layer of the neural network, the checkpoint operation comprising:
obtaining input feature map data for a layer of the neural network;
obtaining the training configuration data;
selecting at least a portion of the input feature map data based on the training configuration data;
processing the selected input feature map data in the layer of the neural network to obtain output feature map data;
selecting at least a portion of the output feature map data based on the training configuration data; and
storing, in the storage circuitry, checkpoint data derived from the selected output feature map data; and
train at least a portion of the neural network based at least on the stored checkpoint data and a loss function.

2. The data processing system of claim 1, wherein for a said layer of the neural network, the said layer being associated with a set of network parameters stored in the storage circuitry, training the at least a portion of the neural network comprises:
obtaining stored checkpoint data corresponding to a previous layer of the neural network;
identifying at least a subset of the network parameters of the said layer that correspond to the stored checkpoint data;
obtaining gradient data corresponding to the at least a subset of the network parameters based on the stored checkpoint data; and
updating the at least a subset of the network parameters based on the gradient data.

3. The data processing system of claim 1, wherein the input data partition parameter corresponds to a receptive field of the neural network, and wherein selecting at least a portion of the input feature map data based on the training configuration data, comprises selecting a portion of the input feature map data based on the receptive field.

4. The data processing system of claim 1, wherein the input feature map data comprises at least one input feature map, and selecting a portion of the input feature map data based on the training configuration data comprises applying the partition to the input feature map to generate:
one or more selected portions of the input feature map; and
one or more unselected portions of the input feature map,
wherein processing the selected input feature map data comprises processing the one or more selected portions of the input feature map and skipping processing for the one or more unselected portions of the input feature map.

5. The data processing system of claim 4, wherein the output feature map data corresponds to the one or more selected portions of the input feature map and the checkpoint data is derived from all of the output feature map data.

6. The data processing system of claim 1, wherein the input feature map data comprises a plurality of input feature maps, and selecting at least a portion of the input feature map data based on the training configuration data comprises applying the partition to the input feature map data to generate:
one or more selected input feature maps from the plurality of input feature maps; and
one or more unselected input feature maps from the plurality of input feature maps, and
wherein processing the selected input feature map data comprises processing the one or more selected input feature maps and skipping processing of the one or more unselected input feature maps.

7. The data processing system of claim 1, wherein the output data partition parameter corresponds to a receptive field of the neural network, and wherein selecting at least a portion of the output feature map data based on the training configuration data, comprises selecting a portion of the output feature map data based on the receptive field.

8. The data processing system of claim 1, wherein the output feature map data comprises at least one output feature map, and selecting at least a portion of the output feature map data based on the training configuration data comprises applying the partition to the output feature map to generate:
one or more selected portions of the output feature map; and
one or more unselected portions of the output feature map, and
wherein the checkpoint data is derived from the one or more selected portions of the output feature map.

9. The data processing system of claim 1, wherein the output feature map data comprises a plurality of output feature maps, and selecting at least a portion of the output feature map data based on the training configuration data comprises applying the partition to the output feature map to generate:
one or more selected output feature maps from the plurality of output feature maps; and
one or more unselected output feature maps from the plurality of output feature maps, and
wherein the checkpoint data is derived from the one or more selected output feature maps.

10. The data processing system of claim 9, wherein for a said layer of the neural network, the said layer being associated with a set of network parameters stored in the storage circuitry, training the at least a portion of the neural network comprises:
obtaining partial gradients corresponding to one or more output feature maps from the plurality of output feature maps;
determining an accumulated gradient based on the partial gradients; and
updating at least a subset of the network parameters corresponding to the one or more output feature maps from the plurality of output feature maps based on the accumulated gradient.

11. The data processing system of claim 1, wherein the processing circuitry is configured to:
process the training configuration data to select one or more of the plurality of layers of the neural network for which the checkpoint operation is to be performed; and
perform the checkpoint operation for the selected layers of the neural network.

12. The data processing system of claim 1, wherein the processing circuitry is configured to generate the training configuration data based on one or more of:
an available storage capacity in the storage circuitry;
an expected execution time for the neural network;
an energy consumption corresponding to processing one or more layers of the neural network; and
a communication bandwidth between the processing circuitry and the storage circuitry.

13. The data processing system of claim 1, comprising a differentiable image signal processor, differentiable ISP, configured to implement the neural network to process input image data to generate output image data.

14. A method of training a neural network comprising a plurality of layers, the method implemented on a data processing system and the method comprising:
in a storage circuitry:
storing training configuration data indicative of a data partition for training the neural network; and
storing checkpoint data for training the neural network; and
in a processing circuitry:
performing a checkpoint operation for at least one layer of the neural network, the checkpoint operation comprising:
obtaining input feature map data for a layer of the neural network;
obtaining the training configuration data;
selecting at least a portion of the input feature map data based on the training configuration data;
processing the selected input feature map data in the layer of the neural network to obtain output feature map data;
selecting at least a portion of the output feature map data based on the training configuration data; and
storing, in the storage circuitry, checkpoint data derived from the selected output feature map data; and
training at least a portion of the neural network based at least on the stored checkpoint data and a loss function.

15. The method of claim 14, wherein:
the training configuration data comprises an input feature map data partition parameter that indicates a partition to be applied to the input feature map data,
the input feature map data comprises at least one input feature map,
selecting a portion of the input feature map data based on the training configuration data comprises applying the partition to the input feature map to generate:
one or more selected portions of the input feature map; and
one or more unselected portions of the input feature map, and
processing the selected input feature map data comprises processing the one or more selected portions of the input feature map and skipping processing for the one or more unselected portions of the input feature map.

16. The method of claim 14, wherein:
the training configuration data comprises an input feature map data partition parameter that indicates a partition to be applied to the input feature map data,
the input feature map data comprises a plurality of input feature maps,
selecting at least a portion of the input feature map data based on the training configuration data comprises applying the partition to the input feature map data to generate:
one or more selected input feature maps from the plurality of input feature maps; and
one or more unselected input feature maps from the plurality of input feature maps; and
processing the selected input feature map data comprises processing the one or more selected input feature maps and skipping processing of the one or more unselected input feature maps.

17. The method of claim 14, wherein:
the training configuration data comprises an output feature map data partition parameter that indicates a partition to be applied to the output feature map data,
the output feature map data comprises at least one output feature map,
selecting at least a portion of the output feature map data based on the training configuration data comprises applying the partition to the output feature map to generate:
one or more selected portions of the output feature map; and
one or more unselected portions of the output feature map; and
the checkpoint data is derived from the one or more selected portions of the output feature map.

18. The method of claim 14, wherein:
the training configuration data comprises an output feature map data partition parameter that indicates a partition to be applied to the output feature map data,
the output feature map data comprises a plurality of output feature maps,
selecting at least a portion of the output feature map data based on the training configuration data comprises applying the partition to the output feature map to generate:
one or more selected output feature maps from the plurality of output feature maps; and
one or more unselected output feature maps from the plurality of output feature maps; and
the checkpoint data is derived from the one or more selected output feature maps.

19. A non-transitory computer-readable medium containing program instructions that, when executed by a processor, cause the processor to perform a method of training a neural network comprising a plurality of layer, the method comprising:
in a storage circuitry:
storing training configuration data indicative of a data partition for training the neural network; and
storing checkpoint data for training the neural network; and
in a processing circuitry:
performing a checkpoint operation for at least one layer of the neural network, the checkpoint operation comprising:
obtaining input feature map data for a layer of the neural network;
obtaining the training configuration data;
selecting at least a portion of the input feature map data based on the training configuration data;
processing the selected input feature map data in the layer of the neural network to obtain output feature map data;
selecting at least a portion of the output feature map data based on the training configuration data; and
storing, in the storage circuitry, checkpoint data derived from the selected output feature map data; and
training at least a portion of the neural network based at least on the stored checkpoint data and a loss function.
